(19) United States
(12) Patent Application Publication
(10) Pub. No.: US 2008/0202004 A1
(43) Pub. Date: Aug. 28, 2008

(54) Bumper sticker game

(76) Inventor: Patricia M. Coleman, Leesburg, FL (US)

Correspondence Address: Leander F. Aulisio, 320 23rd Street #705, Arlington, VA, 22202, US

(21) Appl. No.: 11/710,938

(22) Filed: Feb. 27, 2007

(51) Int. Cl. G09F 21/04

(52) U.S. Cl. 40/591

(57) ABSTRACT

A bumper sticker game and a kit for playing the game, the kit comprising a pair of bumper stickers; one bumper sticker containing a question, and a second bumper sticker containing an answer to the question, wherein the answer is written or printed in reverse image, whereby the reverse image answer is read in a rearview mirror of a passing vehicle.

### BACKGROUND OF THE INVENTION

Bumper stickers have been employed for an extended time to give a driver of a vehicle a way to express himself. Bumper stickers have been employed to let other drivers know that the driver is a fan of a sports team, such as for example the Boston Red Sox. Also, political campaigns make use of bumper stickers to promote their own candidate. Sometimes a bumper sticker is employed to poke fun at a political figure, such as a sticker having the sentence: “Somewhere in Texas a village is missing its idiot.”

A large amount of people spend a substantial amount of their time in a vehicle; and it would be fun to have a game that can be played with bumper stickers. There is a need for novel methods of employing bumper stickers in order to decrease the amount of boredom on today's roadways and highways.

Patent Application Publication US 2004/0016160 to Hudgins discloses a kit for enabling one to make his own personalized bumper sticker. The kit includes a blank bumper sticker and a writing means such as a felt tip marker. An attachment means, which can be magnetic, is also included. If indelible ink is not employed, the message can be wiped off the bumper sticker; and a new message can be written on the bumper sticker.

Patent Application Publication US 2002/0038523 to Gibbens discloses an article containing a printed or written message, wherein at least part of the message is mirror inverted. If the article is a T-shirt, the wearer of the T-shirt can then view the message on his shirt when he stands in front of a mirror. In a further embodiment, the wearer can audibly read the message on the shirt.

Patent Application Publication US 2005/0155264 to Meridith discloses a sign for attachment to the exterior of a vehicle. When attached to a vehicle, the sign mimics that of a person in the vehicle hanging his arm over the edge of the window.

U.S. Pat. No. 5,622,389, issued to Courtney, discloses a bumper sticker device and hassle-free method for mounting and replacing bumper stickers. A clear, trimmable mount sheet is employed for receiving a bumper sticker. The sheet, and not the sticker, is directly attached to the bumper of a vehicle as by two strips of velcro.

U.S. Pat. No. 4,659,111, issued to Credit, discloses a mirror message label system comprising a transparent mirror having a viewing surface disposed on one side thereof and a reflecting surface-disposed on the other side thereof. A flexible, planar label is placed on the surface of the transparent mirror, the label having a message for direct viewing on its front, and a mirror image message on its back.

The above cited references, either taken alone or in combination, do not in any way disclose or imply the present invention as herein described.

### SUMMARY OF THE INVENTION

The present invention relates to a novel game relating to the use of vehicle bumper stickers. Two bumper stickers are employed when the game is played. One bumper sticker is placed on the back bumper of an automobile, and the other bumper sticker is placed on the front bumper of the same automobile. The bumper sticker on the back bumper comprises a question such as a joke question or a trivia question. The bumper sticker on the front bumper comprises an answer to the question that is a joke question or a trivia question.

The game is played by employing a first motorist to drive a first vehicle down the road, the first vehicle having a first bumper sticker on the back bumper, the first bumper sticker containing a question; and a second bumper sticker on the front bumper, the second bumper sticker containing an answer to said question. When the first vehicle is driven down the road, a second motorist in a second vehicle can view the first bumper sticker on the back bumper. The second motorist can then safely drive to the front of the first vehicle. Once safely past the first vehicle, the motorist in the second vehicle can then read the answer to the question.

### BRIEF DESCRIPTION OF THE DRAWING

FIG. 1 is a representation of a pair of bumper stickers wherein a first bumper sticker is a sticker that contains a message that is a joke question. The second bumper sticker contains a message that is an answer to the joke question of the first bumper sticker.

FIG. 2 is a representation of a first bumper sticker with a question; the first bumper sticker being placed on the rear bumper of a vehicle.

FIG. 3 is a representation of a second bumper sticker, with an answer to the question posed on the first bumper sticker. The second bumper sticker is placed on the front bumper of the vehicle that already contains a first bumper sticker on its rear bumper.

### DETAILED DESCRIPTION OF THE INVENTION

A novelty item is hereby disclosed, the item comprising a set of two bumper stickers. A first bumper sticker contains a front face having a question. The question can be a trivia question, such as a movie question, a history question or a sports question. The question can also be a joke question. The question is written or printed in a readable fashion. An attachment means is located on the back face of the first bumper sticker. The attachment means can be an adhesive layer, preferably covering the entire back face of said first bumper sticker. Alternatively, the attachment means can be a Velcro material, die-cut magnetic rubber or separate magnetic pads. In a further embodiment, the attachment means can be suction cups on the back face of the first bumper sticker. If an adhesive composition is employed, it is preferably a weatherproof adhesive composition.

The second bumper sticker contains a front face having an answer to the question posed by the first bumper sticker. The answer is written or printed in a reverse image fashion. The answer can only be read by means of a mirror because it is a mirror image. A second attachment means is located on the back face of the second bumper sticker. The second attachment means can be the same as the first attachment means, or it can be different. The second attachment means can be a weatherproof adhesive composition, a Velcro material, a die-cut magnetic rubber, separate magnetic pads or suction cups.

A method of playing a bumper sticker game is hereby disclosed. The method comprises the following steps. A driver of a vehicle obtains a novelty kit containing two bumper stickers. The first bumper sticker has a front face containing a question. The question can be a trivia question such as a sports question, a history question or a movie question. Alternatively, the question can be a joke question. The first bumper sticker has a back face containing a first attachment means for attaching to a bumper of a vehicle. The first attachment means can be a weatherproof adhesive composition, a Velcro material, a die-cut magnetic rubber, separate magnetic pads or suction cups. The second bumper sticker has a front face containing an answer to the question found on the front face of the first bumper sticker. The answer to the question is written or printed in reverse image. The second bumper sticker has a back face containing a second attachment means. The second attachment means can be the same as the first attachment means, or it can be different.

In a second step of the method for playing the bumper sticker game of the present invention, the driver attaches the first bumper sticker to the rear bumper of his vehicle. He also attaches the second bumper sticker to the front bumper of his vehicle. The driver then drives down the road or highway, and allow other drivers and vehicle occupants to view the bumper stickers. If a second driver is behind the vehicle containing the two bumper stickers, he can read the trivia or joke question. The second driver can then proceed to overtake the vehicle containing the two bumper stickers. After safely passing the vehicle containing the two bumper stickers, the second driver can then view the sticker on the front bumper of the vehicle in his rearview mirror. The second driver then discovers the answer to the trivia or joke question by reading the reverse image in his rearview mirror. The game is then complete.

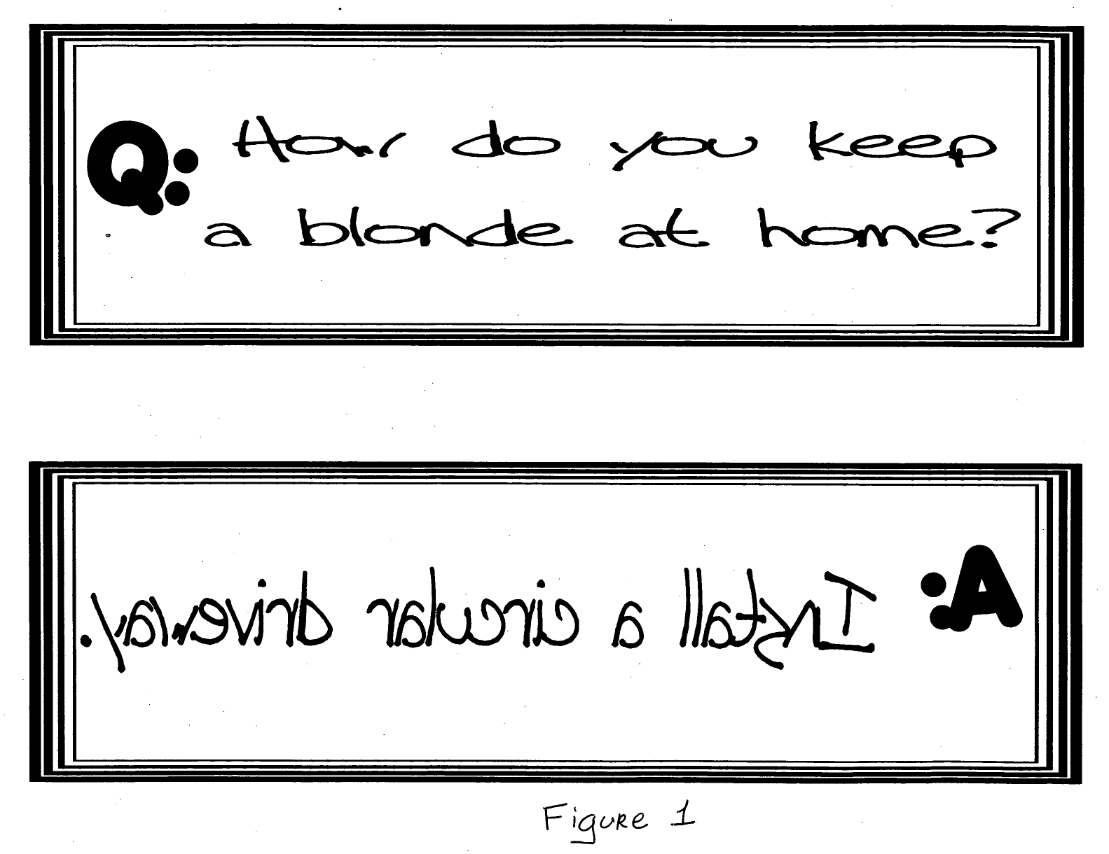

Referring to FIG. 1, a pair of bumper stickers that can be employed in the present invention is represented. It is a pair of stickers wherein one sticker contains a joke question, and the second sticker is the answer to the joke. The wording on the second bumper sticker is in mirror image fashion so that it can be read only with the aid of a mirror, such as a rearview mirror of a vehicle.

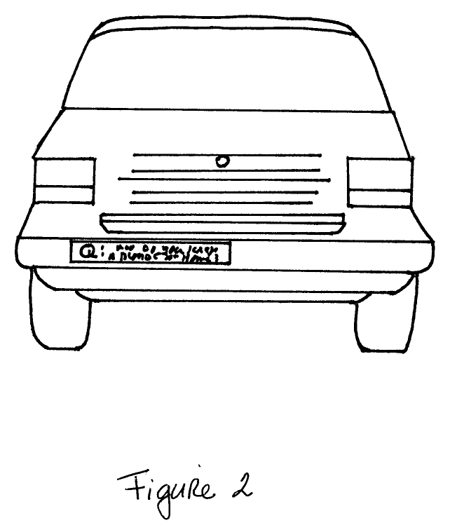

Referring to FIG. 2, a rear view of a vehicle is represented. The vehicle contains a first bumper sticker attached to the rear bumper of said vehicle. The bumper sticker contains a question that is printed in readable fashion.

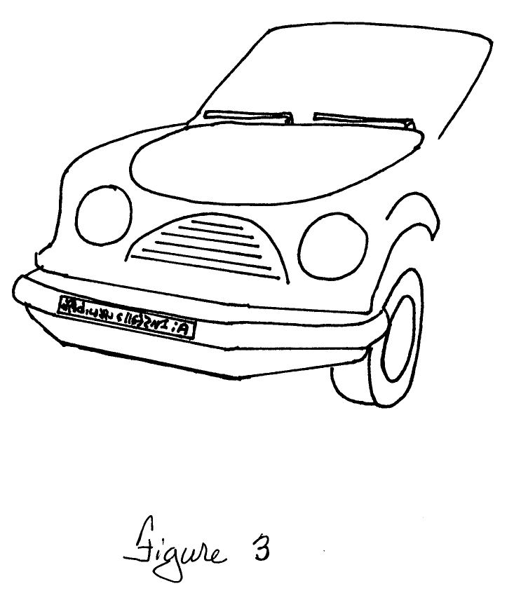

Referring to FIG. 3, a front view of the vehicle represented in FIG. 2 is pictured. The vehicle contains a second bumper sticker attached to the front bumper of the vehicle. The second bumper sticker contains an answer to the question on the first bumper sticker, the answer being printed in reverse image.

While the invention has been described by specific examples and embodiments, there is no intent to limit the inventive concept except as set forth in the following claims.

We claim:

1. A novelty item comprising a set of two bumper stickers, a first bumper sticker containing on a front face thereof a trivia question and on a back face thereof a first attachment means; and a second bumper sticker containing on a front face thereof a trivia answer to said trivia question, and on a back face thereof a second attachment means; whereby the first bumper sticker containing the trivia question is attached as by first attachment means to a rear bumper of a motor vehicle, and the second bumper sticker containing the trivia answer is attached as by second attachment means to the front bumper of said motor vehicle; and whereby the trivia answer to said trivia question is in reverse image.

2. A novelty item according to claim 1 wherein the first and second attachment means are members selected from the group consisting of a weatherproof adhesive composition, die-cut magnetic rubber, separate magnetic pads and suction cups.

3. A novelty item according to claim 2 wherein the first and second attachment means comprise a weatherproof adhesive composition.

4. A novelty item according to claim 1 wherein the reverse image can be read in the rearview mirror of a passing motor vehicle.

5. A method of playing a bumper sticker game, the method comprising the steps of:
(a) obtaining a novelty kit containing two bumper stickers; a first bumper sticker having a front face containing a question, and a back face containing a first attachment means for attaching to a rear bumper of a vehicle; and a second bumper sticker having a front face containing an answer to the question on the front face of the first bumper sticker, the answer to the question being in reverse image, and a back face containing a second attachment means for attaching to a front bumper of the vehicle;
(b) attaching the first bumper sticker to the rear bumper of a vehicle by using first attachment means; and attaching the second bumper sticker to the front bumper of the vehicle by using second attachment means;
(c) driving the vehicle containing the two bumper stickers down a road;
(d) allowing other drivers to view the first sticker on the rear bumper of the vehicle;
(e) allowing said other drivers to overtake the vehicle containing the two bumper stickers;
(f) allowing said other drivers to view the second sticker on the front bumper of the vehicle by employing other drivers' rearview mirrors, whereby the other drivers discover the answer to the question on the first sticker.
